(19) United States
(12) Patent Application Publication
(10) Pub. No.: US 2013/0113543 A1
(43) Pub. Date: May 9, 2013

(54) MULTIPLICATION DYNAMIC RANGE INCREASE BY ON THE FLY DATA SCALING

(71) Applicants: Leonid Dubrovin, Karney Shomron (IL); Alexander Rabinovitch, Kfar Yona (IL); Amichay Amitay, Hod Hasharon (IL)

(72) Inventors: Leonid Dubrovin, Karney Shomron (IL); Alexander Rabinovitch, Kfar Yona (IL); Amichay Amitay, Hod Hasharon (IL)

(21) Appl. No.: 13/292,377

(22) Filed: Nov. 9, 2011

(51) Int. Cl. G06G 7/16

(52) U.S. Cl. 327/356

(57) ABSTRACT

An apparatus having a first circuit and a second circuit is disclosed. The first circuit may be configured to (i) receive two input signals. Each input signal generally carries a respective data value. Each data value may have a respective sign bit and a respective at least one guard bit. The first circuit may also be configured to (ii) scale each data value independently such that all of the respective guard bits have a same value as the respective sign bit and (iii) generate a product value in an output signal by adjusting an intermediate value based on the scaling of the data values. The second circuit may be configured to generate the intermediate value by multiplying the two data values as scaled.

### FIELD OF THE INVENTION

The present invention relates to digital multiplication generally and, more particularly, to a method and/or apparatus for implementing a multiplication dynamic range increase by on the fly data scaling.

### BACKGROUND OF THE INVENTION

Consecutive complex number multiplications and additions are performed in many digital signal processor (i.e., DSP). For example, in a calculation of a radix-5 butterfly fast Fourier transform (i.e., FFT) decimation-in-time (i.e., DIT) operation, complex inputs to the butterfly are rotated through multiplication by a complex twiddle factor followed by another multiplication by a complex factor. The results of the two multiplications are subsequently added. Many other complex calculations have similar behavior.

A problem with such complex kinds of calculations is that one or more intermediate values commonly overflow. Many existing DSP cores allow an addition of two full-scaled fractional complex numbers (i.e., 16-bit real and 16-bit imaginary parts in a fixed point representation) with several guard bits (i.e., 4 or 8 guard bits) to prevent an overflow of the result. The problem usually appears when the result of the addition is used as an input to a multiplication because the multipliers have a fixed input bit-width (i.e., 16 bits). In cases involving consecutive complex multiplications, an initial multiplication of complex numbers by complex numbers can cause the data to overflow in the subsequent multiplication operation.

The overflow problem is usually solved either by a static or a dynamic pre-scaling of the data. In the static pre-scaling approach, the data is always scaled before being used in the calculations to prevent the overflow. The static pre-scaling is performed without checking the actual data values. The number of bits by which the data is scaled is the number of potential overflow bits. In the dynamic scaling approach, the data values are checked and scaled if a possibility exists for an overflow. Both approaches are applied to blocks of multiple data values so the scaling for the whole blocks is constant for each data value. Thus, even in dynamic scaling approach, a small data value would be scaled if a large data value exists in the same block. The approaches also cause calculation precision degradation. Scaling earlier in the calculation flows and/or scaling by larger amounts increases a degradation in the precision of the calculation.

In some applications, a final result of the calculation is limited to a predefined (i.e., saturated) value to avoid an overflow. However, intermediate results can accept larger values than the final result. In such cases, the dynamic range of the intermediate results is still limited to the maximum input bit-width of the multiplier. Alternatively, increasing the input bit-width of the multiplier is expensive in terms of chip area.

It would be desirable to implement a method and/or apparatus for a multiplication dynamic range increase by on the fly data scaling.

### SUMMARY OF THE INVENTION

The present invention concerns an apparatus having a first circuit and a second circuit. The first circuit may be configured to (i) receive two input signals. Each input signal generally carries a respective data value. Each data value may have a respective sign bit and a respective at least one guard bit. The first circuit may also be configured to (ii) scale each data value independently such that all of the respective guard bits have a same value as the respective sign bit and (iii) generate a product value in an output signal by adjusting an intermediate value based on the scaling of the data values. The second circuit may be configured to generate the intermediate value by multiplying the two data values as scaled.

The objects, features and advantages of the present invention include providing a method and/or apparatus for implementing a multiplication dynamic range increase by on the fly data scaling that may (i) pre-scale each data value individually, (ii) post-scale a result value based on the pre-scaling, (iii) accommodate fixed input bit-widths of multipliers, (iv) operate on signed data values (v) increase a multiplier input data dynamic range and/or (vi) be implemented in a digital signal processor.

### BRIEF DESCRIPTION OF THE DRAWINGS

These and other objects, features and advantages of the present invention will be apparent from the following detailed description and the appended claims and drawings in which_{:}

FIG. 1 is a block diagram of an example implementation of an apparatus;

FIG. 2 is a block diagram of an example implementation of a multiplier circuit in the apparatus;

FIG. 3 is a diagram of an example format of a data word;

FIG. 4 is a flow diagram of an example method of operation for the multiplier circuit in accordance with a preferred embodiment of the present invention;

FIG. 5 is a diagram of an example fractional multiplication of a complex number by another complex number;

FIG. 6 is a diagram of an example pre-scaling of a data value;

FIG. 7 is a diagram of another example pre-scaling of a data value; and

FIG. 8 is a diagram of an example multiplication of two data values.

### DETAILED DESCRIPTION OF THE PREFERRED EMBODIMENTS

Some embodiments of the present invention may be implemented as digital signal processor (e.g., DSP) core instructions and/or hardware implementations that perform multiplication with on the fly input data scaling and output data scaling to prevent data overflows. Some implementations may increase a multiplier input data dynamic range. Some implementations may remove fixed size multiplier restrictions. The pre-scaling operations and the post-scaling operations may be included into the multiplier. The pre-scaling generally removes a restriction that intermediate results calculated in earlier DSP core operations should fit an input bit-width criteria of the multiplier.

The following considerations may be taken into account in some embodiments of the present invention. Results of all calculations may be stored in registers with guard bits to prevent overflows. The calculations may be performed with fractional data. Therefore, if a result of one or more multiplications and/or additions produces more bits than a multiplier input width (e.g., N bits), the highest N bits may be used as the input into the multiplier. If the result of a calculation does not overflow, each of the guard bits may have a same value (e.g., 0 or 1) as the sign bit of the result. Otherwise, the guard bits may contain additional information.

Consider a case where N=16 and the number of guard bits is 4. If two real 16-bit signed fractional numbers are multiplied together, the result is generally a 32-bit signed number and the guard bits may have the same value as the sign bit. If two such 32-bit numbers are added, the result may not fit in a 32-bit number and so at least a single guard bit may differ from the sign bit.

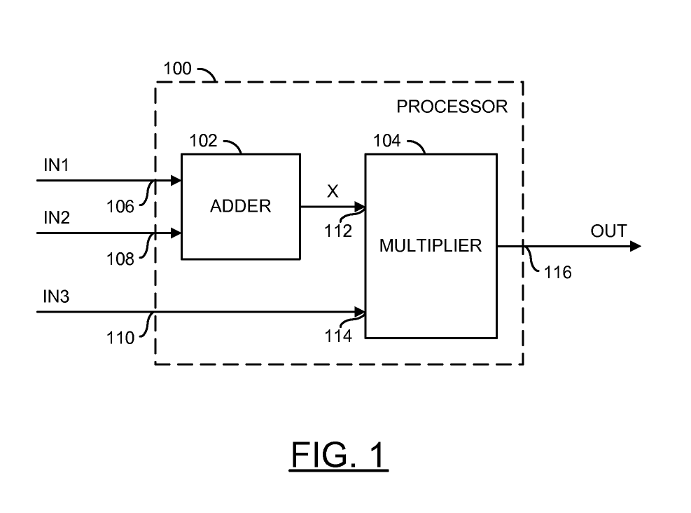

Referring to FIG. 1, a block diagram of an example implementation of an apparatus 100 is shown. The apparatus (or circuit or device or integrated circuit) 100 may implement a DSP core. The apparatus 100 generally comprises a block (or circuit) 102 and a block (or circuit) 104. The circuits 102-104 may represent modules and/or blocks that may be implemented as hardware, software, a combination of hardware and software, or other implementations.

A signal (e.g., IN1) may be received at an input 106 of the apparatus 100. A signal (e.g., IN2) may be received at an input 108 of the apparatus 100. An input 110 of the apparatus 100 may receive a signal (e.g., IN3). The circuit 102 may generate a signal (e.g., X) received at an input 112 of the circuit 104. An input 114 of the circuit 104 may receive the signal IN3. A signal (e.g., OUT) may be generated by the circuit 104. The signal OUT may be presented at an output 116 of the apparatus 100.

The circuit 102 may implement an adder circuit. The circuit 102 is generally operational to add two values as received in the signals IN1 and IN2. A sum of the two values may be presented in the signal X. Each value in the signals IN1 and IN2 may be represented as J-bit (e.g., 36-bit) values. The sum value in the signal X may be represented as a K-bit (e.g., 37-bit) value, where K≧J.

The circuit 104 may implement a multiplier circuit. The circuit 104 is generally operational to multiply the values received in the signals X and IN3. A product of the multiplication may be presented in the signal OUT. In some embodiments, the product value may be represented as a J-bit (e.g., 36-bit) value. Individual pre-scaling of the multiplicands is generally used by the circuit 104 to deal with overflows and excessively large numbers. The circuit 104 may be configured to receive the signals X and IN3. Each signal X and IN3 generally carries a respective data value for a respective multiplicand. Each data value generally comprising a respective sign bit and one or more guard bits. A multiplication instruction and/or hardware generally finds a number of bits (e.g., K₁ bits and K₂ bits) that each multiplicand is to be shifted to make all of the guard bits match the respective sign bits. The circuit 104 may shift (scale by powers of two) each data value independently such that all of the respective guard bits have a same value as the respective sign bit. Each shifted data value may be rounded to match an input bit-width of the multiplication. The circuit 104 may be further configured to generate an intermediate value by multiplying the two data values as scaled and rounded. Thereafter, the circuit 104 may generate a product value in the signal OUT by adjusting (e.g., shifting left by K₁+K₂ bits) the intermediate value based on the scaling of the data values.

By implementing the circuit 104 as described, the apparatus 100 generally does not perform speculative pre-scaling and no scaling is done on small data values. All operations may be performed with high precision. Minimal precision loses may be caused in the calculated result (multiplication product).

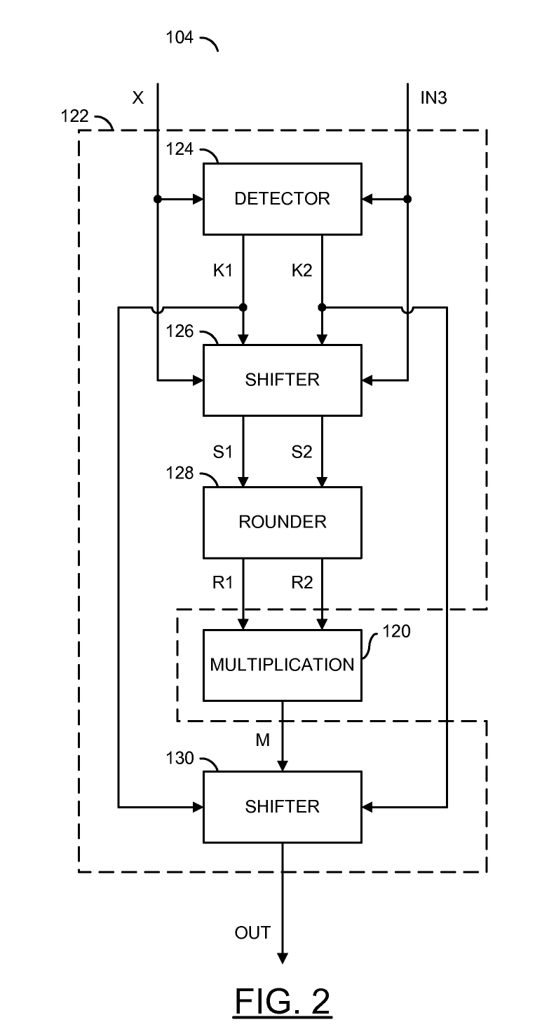

Referring to FIG. 2, a block diagram of an example implementation of the circuit 104 is shown. The circuit 104 generally comprises a block (or circuit) 120 and a block (or circuit) 122. The circuit 122 generally comprises a block (or circuit) 124, a block (or circuit) 126, a block (or circuit) 128 and a block (or circuit) 130. The circuits 120-130 may represent modules and/or blocks that may be implemented as hardware, software, a combination of hardware and software, or other implementations.

The signals X and IN3 may be received by the circuits 124 and 126. The circuit 124 may generate a pair of signals (e.g., K1 and K2) received by the circuits 126 and 130. The circuit 126 may generate a pair of signals (e.g., S1 and S2) received by the circuit 128. A pair of signals (e.g., R1 and R2) may be generated by the circuit 128 and presented to the circuit 120. The circuit 120 may generate a signal (e.g., M) received by the circuit 130. The signal OUT may be generated by the circuit 130.

The circuit 120 may implement a multiplication circuit. The circuit 120 is generally operational to multiply two multiplicands receive in the signals R1 and R2 to calculate an intermediate (multiplication product) value in the signal M. The circuit 120 generally has a multi-bit (e.g., 16 or 32-bit) input limit on a size (or number of bits) of each multiplicand value.

The circuit 122 may be implemented as an on the fly scaling circuit. The circuit 122 is generally operational to pre-scale each multiplicand value received via the signals X and IN3 before the actual multiplication performed in the circuit 120. The circuit 122 may also be operational to post-scale the resulting intermediate value in the signal M to reverse (or undo) the pre-scaling. The pre-scaling may include, but is not limited to, determining a respective number of bits (e.g., K₁ and K₂) to independently bit-shift each multiplicand value rightward (divide by a power of two). The circuit 122 may subsequently scale each multiplicand value independently based on the respective number of bits K₁ and K₂ such that all of the respective guard bits have a same value as the respective sign bit. Furthermore, each multiplicand value may be rounded to fit the input bit-width of the circuit 120. The post-scaling may include, but is not limited to, generating an adjusted (final product) value by adjusting said intermediate value based on the values of K₁ and K₂. The adjusted value may be presented in the signal OUT.

The circuit 124 may implement a detection circuit. The circuit 124 may be operational to examine each multiplicand value to determine (detect) a respective scale factor. The scale factors may represent the number of bits by which each multiplicand value should be shifted such that all of the guard bits match the value (e.g., 0 or 1) of the respective sign bit. For the multiplicand value received in the signal X, the circuit 124 may determine and present the value K₁ in the signal K1. For the multiplicand value received in the signal IN3, the circuit 124 may determine and present the value K₂ in the signal K2.

The circuit 126 may implement a shifter circuit. The circuit 126 is generally operational to shift the multiplicand values by the respective K₁ and K₂ values. The multiplicand value received in the signal X may be shifted rightward (scaled down or divided) by K₁ bits. The resulting scaled value may be presented in the signal S1. The multiplicand value received in the signal IN3 may be shifted rightward (scaled down or divided) by K₂ bits. The resulting scaled value may be presented in the signal S2. Bits shifted to the right of the least significant bit may be discarded. The sign bit value may be right shifted into the most significant bit during each shift.

The circuit 128 may implement a rounder circuit. The circuit 128 is generally operational to round the shifted values to a limited number (e.g., 16) of bits. The rounding generally discards one or more of the least significant bits. The rounding may also discard the sign bit and all but a single guard bit. The most significant among the rounded bits (now having the same value as the original sign bit) may be kept as a new sign bit. The rounded number of bits may be designed to match the input hit-width of the circuit 120.

The circuit 130 implement a shifter circuit. The circuit 130 is generally operational to shift the intermediate value received in the signal M to undo the shifting performed in the circuit 126. The intermediate value may be shifted leftward by a sum of K₁ and K₂. A zero value may be left shifted into the least significant bit during each shift. The shifted value may be presented in the signal OUT.

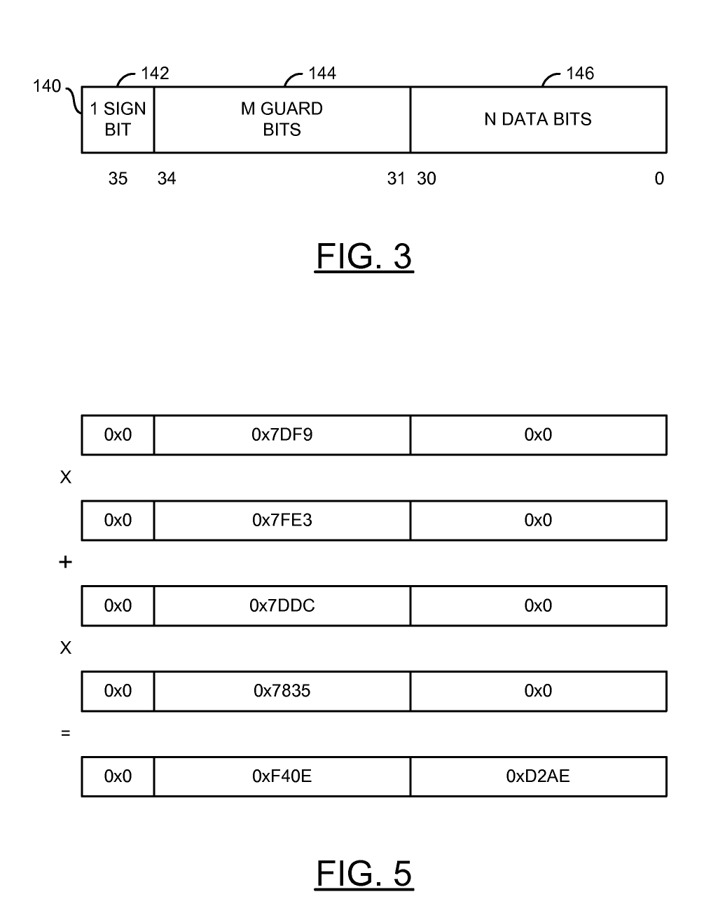

Referring to FIG. 3, a diagram of an example format of a data word 140 is shown. Each data word 140 generally comprises a sign bit 142, one or more optional guard bits 144 and multiple data bits 146. In the example shown, a 36-bit data word 140 may have a sign bit 142 in the most significant (leftmost) bit position (e.g., bit 35). The guard bits 144 may occupy the next most significant bit positions (e.g., bits 34-31). The data bits 146 may be located in the rest of the data word 140 (e.g., bits 30-0). The sign bit, guard bits and data bits may form a data value.

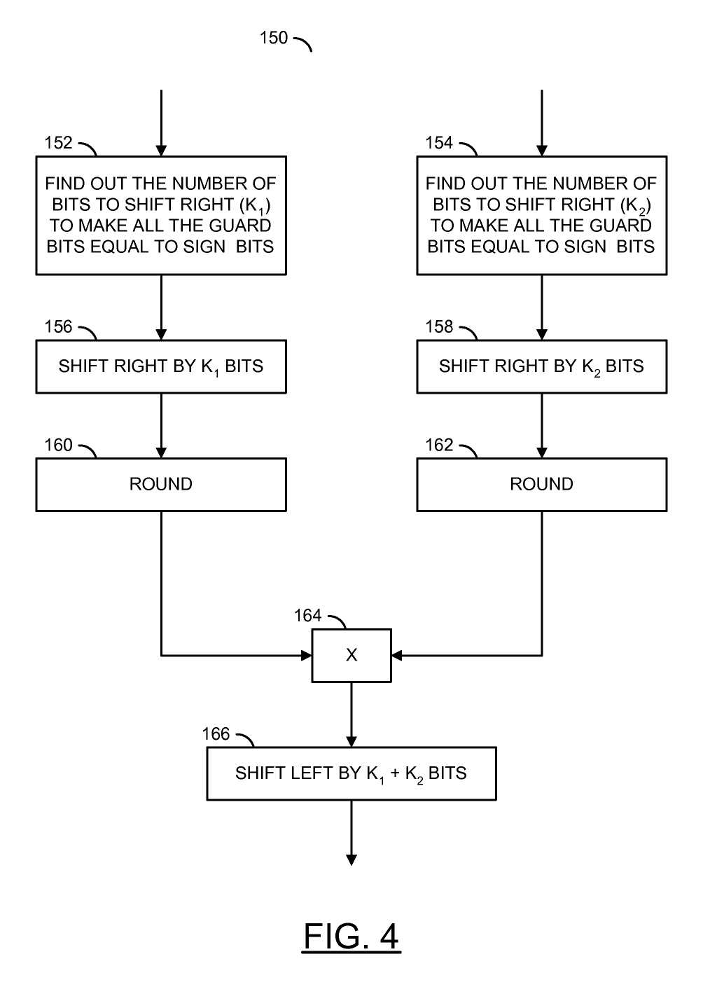

Referring to FIG. 4, a flow diagram of an example method 150 of operation for the circuit 104 is shown in accordance with a preferred embodiment of the present invention. The method (or process) 150 generally comprises a step (or state) 152, a step (or state) 154, a step (or state) 156, a step (or state) 158, a step (or state) 160, a step (or state) 162, a step (or state) 164 and a step (or state) 166. The steps 152-166 may represent modules and/or blocks that may be implemented as hardware, software, a combination of hardware and software, or other implementations.

In the step 152, the circuit 124 may find the number of bits K₁ to shift right the multiplicand value received in the signal X. In parallel (or sequentially), the circuit 124 may also find the number of bits K₂ to shift right the multiplicand value received in the signal IN3 in the step 154. In the steps 156 and 158, the circuit 126 may shift rightward the multiplicand values by K₁ bits and K₂ bits respectively. The circuit 128 may round each shifted value in the respective steps 160 and 162. In the step 164, the circuit 120 may multiply the shifted-and-rounded values to generate the intermediate value. The circuit 130 may shift left the intermediate value by a sum of the K₁ and K₂ bits (e.g., K₁+K₂ bits). The resulting value may be the final product value presented in the signal OUT.

Referring to FIG. 5, a diagram of an example fractional multiplication of a complex number by another complex number is shown. The example may only illustrate an imaginary part of each complex number. A product of two multiplicand data values is generally shown being added to a product of two other multiplicand data values, each data value having a zero sign bit (e.g., 0x0, where “0x” may indicate a hexadecimal value). To adjust the multiplicand values to fit a fixed bit-width (e.g., 16 bits) input of a multiplier circuit, the K bits for each data value may be determined per the steps 152-154. The data values may be shifted right per steps 156-158 and rounded per steps 160-162. The example 16-bit rounded values shown may be 0x7DF9, 0x7FE3, 0x7DDC and 0x7835. In the step 164, products for each shifted-and-rounded data pair may be calculated. Each product may subsequently be shifted left per step 166. The products may then be added to produce a sum value (e.g., 0x0 F40E D2AE).

Referring to FIG. 6, a diagram of an example pre-scaling of a data value is shown. The data value (e.g., 0x0 F40E D2AE) is illustrated in bit form in the top row. A shift left by a single bit (e.g., K₁=1) may be incorporated into the multiplication because the multiplication is fractional. The fractional data bits are generally stored in bits 0 through 30 (e.g., 31 bits) as defined in FIG. 3. The guard bits (G) may be bits 31 through 34 (e.g., 4 bits). The sign bit (S) may be bit 35. FIG. 6 generally shows that not all guard bits (e.g., 0001) may match the sign bit (e.g., the rightmost guard bit is 1 and the sign bit is 0). Only the single guard bit is different from the sign bit. Therefore, to multiply the result by a real number, the data value is shifted right by a bit and rounded before being multiplied. The resulting shifted value may be 0x0 7A07 6957. The shifted value may subsequently be rounded in the circuit 128. The rounding may retain in the shifted data bits 16-31 (e.g., 16 bits) with bit 31 being used as the sign bit. The rounding may consider bit 15 when determining to round up or round down. The rounded value illustrated may be 0x7A07 (rounded down because bit 15 has a binary 0 value). The rounded value may be presented to the circuit 120 in the signal R1.

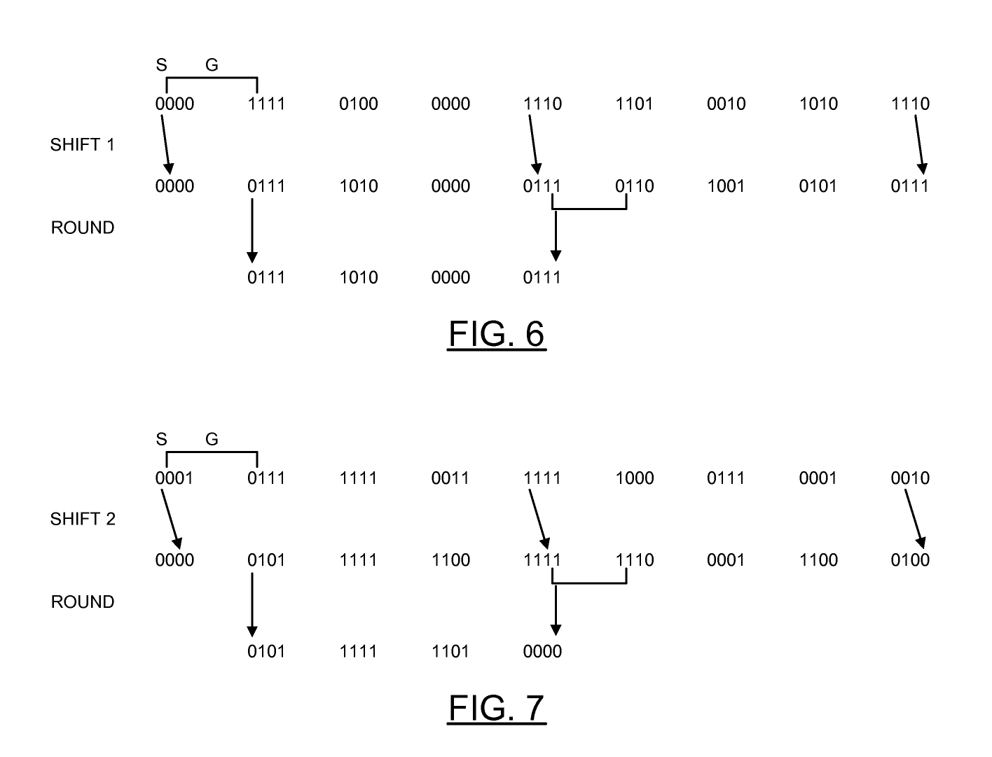

Referring to FIG. 7, a diagram of another example pre-scaling of a data value is shown. The data value (e.g., 0x1 7F3F 8712) is illustrated in bit form in the top row. A shift left by two bits (e.g., K₂=2) may be incorporated into the multiplication because the multiplication is fractional. The fractional data bits are generally stored in bits 0 through 30 (e.g., 31 bits) as defined in FIG. 3. The guard bits (G) may be bits 31 through 34 (e.g., 4 bits). The sign bit (S) may be bit 35. FIG. 7 may also show that not all guard bits (e.g., 0010) may match the sign bit (e.g., the second rightmost guard bit is 1 and the sign bit is 0).

Only the single guard bit is different from the sign bit. Therefore, to multiply the result by a real number, the data value may be shifted right by two bits and rounded before being multiplied. The shifted value may be 0x0 5FCF E1C4. The shifted value may subsequently be rounded by the circuit 128. The rounding may retain in the shifted data bits 16-31 (e.g., 16 bits) with bit 31 being used as the sign bit. The rounding may consider bit 15 when determining to round up or round down. The rounded value illustrated may be 0x5FD0 (rounded up because bit 15 has a binary 1 value). The rounded value may be presented to the circuit 120 in the signal R2.

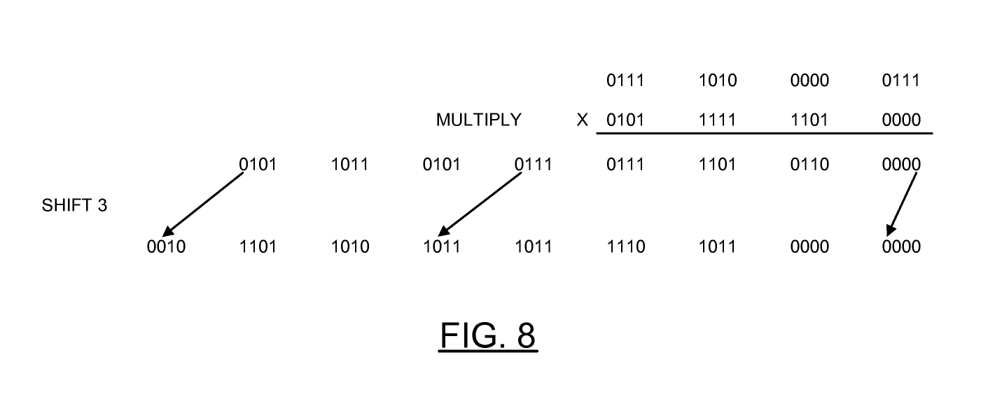

Referring to FIG. 8, a diagram of an example multiplication of two data values is shown. The two data values may be the 16-bit rounded values from FIGS. 6 and 7. Multiplying the 16-bit values 0x7A07 by 0x5FD0 may create a 32-bit intermediate product value (e.g., 0x5B57 7D60). The intermediate product value may be presented in the signal M from the circuit 120 to the circuit 130. A sum of K₁+K₂ may be 3. Therefore, the intermediate product value may be shifted left by 3 bits in the circuit 130 to create the final product value (e.g., 0x2 DABB EB00). A zero value may be left shifted into the least significant bit position at each shift. Unused most significant bits may be padded with zero values. The 36-bit product value may be presented in the signal OUT from the circuit 130.

The functions performed by the diagrams of FIGS. 1, 2 and 4 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a first circuit configured to (i) receive two input signals, wherein (a) each of said input signals carries a respective data value and (b) each of said data values comprising a respective sign bit and a respective at least one guard bit, (ii) scale each of said data values independently such that all of said respective guard bits have a same value as said respective sign bit and (iii) generate a product value in an output signal by adjusting an intermediate value based on said scaling of said data values; and
a second circuit configured to generate said intermediate value by multiplying said two data values as scaled.

2. The apparatus according to claim 1, wherein said first circuit is further configured to round each of said data values after said scaling.

3. The apparatus according to claim 2, wherein each of said data values as scaled and rounded fits a bit-width restriction on an input of said multiplying of said second circuit.

4. The apparatus according to claim 3, wherein at least one of said data values prior to said scaling has a larger bit-width than said bit-width restriction of said multiplying.

5. The apparatus according to claim 1, wherein said first circuit is further configured to determine a respective number of bits to bit-shift each of said data values independently rightward prior to said scaling.

6. The apparatus according to claim 5, wherein a first of said respective number of bits is determined not to match a second of said respective number of bits.

7. The apparatus according to claim 1, wherein said adjusting of said intermediate value comprises a bit-shift of said intermediate value leftward.

8. The apparatus according to claim 7, wherein said intermediate value is bit-shifted leftward a same total number of bits as said data values are bit-shifted rightward in said scaling.

9. The apparatus according to claim 1, wherein said first circuit and said second circuit form part of a digital signal processor.

10. The apparatus according to claim 1, wherein said apparatus is implemented as one or more integrated circuits.

11. A method for increasing multiplication dynamic range by on the fly data scaling, comprising the steps of:
(A) receiving two input signals, wherein (i) each of said input signals carries a respective data value and (ii) each of said data values comprising a respective sign bit and a respective at least one guard bit;
(B) scaling each of said data values independently such that all of said respective guard bits have a same value as said respective sign bit;
(C) generating an intermediate value by multiplying said two data values as scaled in a circuit; and
(D) generating a product value in an output signal by adjusting said intermediate value based on said scaling of said data values.

12. The method according to claim 11, further comprising the step of:
rounding each of said data values after said scaling.

13. The method according to claim 12, wherein each of said data values as scaled and rounded fits a bit-width restriction on an input of said multiplying.

14. The method according to claim 13, wherein at least one of said data values prior to said scaling has a larger bit-width than said bit-width restriction of said multiplying.

15. The method according to claim 11, further comprising the step of:
determining a respective number of bits to bit-shift each of said data values independently rightward prior to said scaling.

16. The method according to claim 15, wherein a first of said respective number of bits is determined not to match a second of said respective number of bits.

17. The method according to claim 11, wherein said adjusting of said intermediate value comprises bit-shifting said intermediate value leftward.

18. The method according to claim 17, wherein said intermediate value is bit-shifted leftward a same total number of bits as said data values are bit-shifted rightward in said scaling.

19. The method according to claim 11, wherein said method is implemented in a digital signal processor.

20. An apparatus comprising:
means for receiving two input signals, wherein (i) each of said input signals carries a respective data value and (ii) each of said data values comprising a respective sign bit and a respective at least one guard bit;
means for scaling each of said data values independently such that all of said respective guard bits have a same value as said respective sign bit;
means for generating an intermediate value by multiplying said two data values as scaled; and
means for generating a product value in an output signal by adjusting said intermediate value based on said scaling of said data values.
